(19) United States
(12) Patent Application Publication
(10) Pub. No.: US 2024/0386812 A1
(43) Pub. Date: Nov. 21, 2024

(54) SPLICING METHOD OF MATHEMATICAL TEACHING TOOL

(71) Applicant: TSANG-HSI CHUNG, Taipei (TW)

(72) Inventor: MINGKAI ZHANG, Jinhua (TW)

(21) Appl. No.: 18/662,731

(22) Filed: May 13, 2024

(30) Foreign Application Priority Data
May 17, 2023 (CN) 202310557213.3

(51) Int. Cl. G09B 19/02

(52) U.S. Cl. CPC G09B 19/02

(57) ABSTRACT

A splicing method of a mathematical teaching tool is provided, which includes: S1. providing a first carrier plate, a second carrier plate, and a third carrier plate; S2. splicing, connecting the first carrier plate and second carrier plate in a fixed connection manner, connecting the first carrier plate and the third carrier plate in a detachable connection manner; S3, forming a right-angled triangle area between the first carrier plate, the second carrier plate, and the third carrier plate; S4. filling an area, forming three square, three regular triangle, or three semi-circular wooden boxes into a whole with a hinge lock connection and a fixed connection way. Building block boxes are connected with the hinge lock connection. The traditional calculation proof of the Pythagorean theorem in paper is transformed into a proof method of block splicing, a unit area is expressed with blocks of the same size.

### CROSS-REFERENCE TO RELATED APPLICATIONS

This application claims priority to Chinese Patent Application No. 202310557213.3, filed on May 17, 2023, which is hereby incorporated by reference in its entirety.

### TECHNICAL FIELD

The present disclosure relates to the field of teaching aids technologies, and in particular, to a splicing method of a mathematical teaching tool.

### BACKGROUND

At present, there are a variety of teaching tools. In mathematics teaching, a tool used to prove the Pythagorean theorem is relatively special. Pythagorean theorem is an important knowledge that students must master. In existing traditional mathematics teaching, most teachers first display a corresponding graphic, and then paper and pen are used with a mathematical method to deduce and prove the Pythagorean theorem; a general teaching aid for Pythagorean theorem can only use geometric shapes to place on the drawn drawings, thus a concept of a complete toy is lacked. This can reduce children's desire to play and make it difficult to stimulate their enthusiasm for hands-on operation.

### SUMMARY

To solve the above problems, the present disclosure proposes a splicing method of a mathematical teaching tool, which solves a problem of using geometric shapes on a drawn drawing to place a general Pythagorean theorem teaching tool, which lacks a concept of a complete toy. This will reduce children's desire to play and stimulate their enthusiasm for hands-on operation.

The technical solution adopted by the present disclosure is: a splicing method of a mathematical teaching tool, including the following steps:
S1: providing a first carrier plate, a second carrier plate, and a third carrier plate; where a first inner cavity is formed in an inner side of the first carrier plate; a second inner cavity is formed in an inner side of the second carrier plate; a third inner cavity is formed in an inner side of the third carrier plate;
S2. splicing: connecting the first carrier plate to the second carrier plate in a fixed connection manner, connecting the third carrier plate to the first carrier plate in a detachable connection manner;
S3. forming a right-angled triangle area: a lower right corner of the first carrier plate is connected to an upper right corner of the second carrier plate, an end of one side of the third carrier plate is connected to an upper right corner of the first carrier plate, and the other end of the third carrier plate is connected to the upper right corner of the second carrier plate, a space formed between the first carrier plate, the second carrier plate, and the third carrier plate is the right-angled triangle area;
S4. filling an area: a plurality sets of splicing plates are placed on inner sides of the first inner cavity and the second inner cavity, the splicing plates formed on the inner sides of the first inner cavity and the second inner cavity fill an inner side of the third inner cavity.

In an embodiment, in step S2, performing a right-angle verification on a spliced carrier plate:
a first verification groove is formed at the first carrier plate close to a side surface of a right-angled part of the right-angled triangle area;
a second verification groove is formed at the second carrier plate close to an upper end face of the right-angled part of the right-angled triangle area;
a verification groove is formed by an interconnection between the first verification groove and the second verification groove, and a verification piece is provided on an inner side of the verification groove.

In an embodiment, in step S2, the fixed connection includes a woodworking adhesive bonding.

In an embodiment, in step S2, the detachable connection is a hinge lock.

In an embodiment, in step S1, the first carrier plate, the second carrier plate, and the third carrier plate are all squares, and upper end faces of the first carrier plate, the second carrier plate, and the third carrier plate are all provided with a prompt sign on two sides.

In an embodiment, in step S1, the first carrier plate, the second carrier plate, and the third carrier plate are all regular triangle.

In an embodiment, in step S1, the first carrier plate, the second carrier plate, and the third carrier plate are all semi-circular.

Compared with prior art, the present disclosure has the following beneficial effects: three square, three square, or three semi-circular wooden boxes are transformed into a whole with a hinge lock connection and a fixed connection way. As building blocks are the most easily accessible toy for children, they are connected with a hinge lock. The traditional calculation proof of the Pythagorean theorem in paper is transformed into a proof method of block splicing, a unit area is expressed with blocks of the same size, which effectively solving the problem of reducing children's desire to play due to a lack of overall toy concepts, as well as a difficulty in mobilizing children's enthusiasm for hands-on operation.

### BRIEF DESCRIPTION OF DRAWINGS

In order to provide a clearer explanation of the embodiments of the present disclosure or the technical solutions in the prior art, a brief introduction will be given below to the accompanying drawings required in the embodiments or prior art description. It is evident that the accompanying drawings in the following description are only some embodiments of the present disclosure. For those skilled in the art, other accompanying drawings can be obtained based on structures shown in these drawings without creative work.

FIG. 1 is an overall square structure diagram of a carrier plate of the present disclosure.

FIG. 2 is the overall square structure diagram of the carrier plate of the present disclosure.

FIG. 3 is the overall square structure diagram of the carrier plate of the present disclosure.

FIG. 4 is the overall square structure diagram of the carrier plate of the present disclosure.

FIG. 5 is the overall square structure diagram of the carrier plate of the present

disclosure.

FIG. 6 is the overall square structure diagram of the carrier plate of the present disclosure.

FIG. 7 is the overall square structure diagram of the carrier plate of the present disclosure.

FIG. 8 is an overall regular triangle structure diagram of the carrier plate of the present disclosure.

FIG. 9 is the overall regular triangle structure diagram of the carrier plate of the present disclosure.

FIG. 10 is the overall regular triangle structure diagram of the carrier plate of the present disclosure.

FIG. 11 is an overall semi-circular structure diagram of the carrier plate of the present disclosure.

FIG. 12 is the semi-circular overall structure diagram of the carrier plate of the present disclosure.

FIG. 13 is the semi-circular overall structure diagram of the carrier plate of the present disclosure.

FIG. 14 is a calculation of an overall square structure area and a proof of a graphical relationship of the present disclosure.

FIG. 15 is the calculation of an overall regular triangle structural area and the proof of graphical relationship of the present disclosure.

The implementation, functional characteristics, and advantages of the present disclosure will be further explained in combination with the embodiments, with reference to the accompanying drawings.

### DESCRIPTION OF EMBODIMENTS

The following will provide a clear and complete description of the technical solution in the embodiments of the present disclosure, in combination with the accompanying drawings. Obviously, the described embodiments are only a part of the embodiments of the present disclosure, not all of them. Based on the embodiments in the present disclosure, all other embodiments obtained by those skilled in the art without creative work fall within the protection scope of the present disclosure.

It should be noted that all directional indications (such as up, down, left, right, front, back . . . ) in the embodiments of the present disclosure are only used to explain a relative position relationship and motion situation between components in a specific posture (as shown in the drawing). If a specific posture changes, the directional indication also changes accordingly.

In addition, the wording of “first”, “second”, etc. in the present disclosure is only for a purpose of description and cannot be understood as indicating or implying their relative importance or implying the number of indicated technical features. Therefore, the features limited to “first” and “second” can explicitly or implicitly include at least one of these features. In addition, the technical solutions between various embodiments can be combined with each other, but must be based on what ordinary technicians in the art can achieve. When the combination of technical solutions is contradictory or impossible to achieve, it should be considered that the combination of such technical solutions does not exist and is not within the protection scope that is required by the present disclosure.

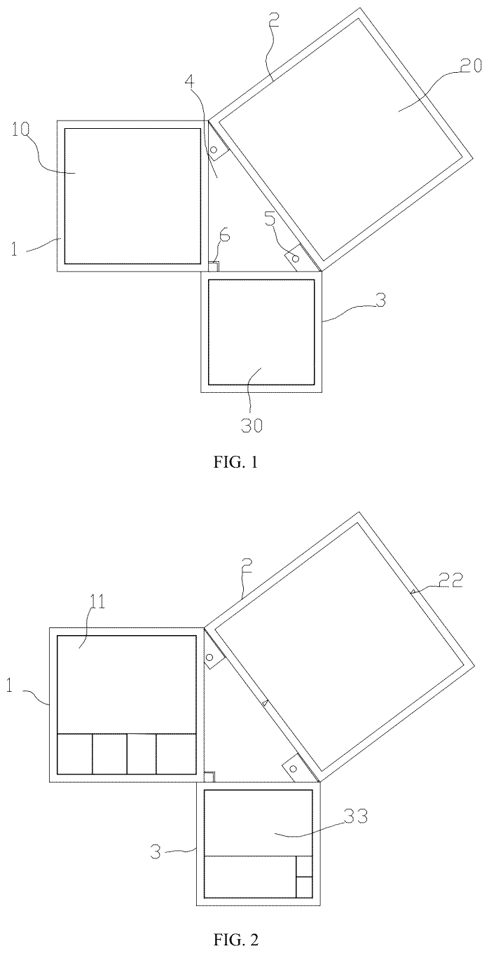

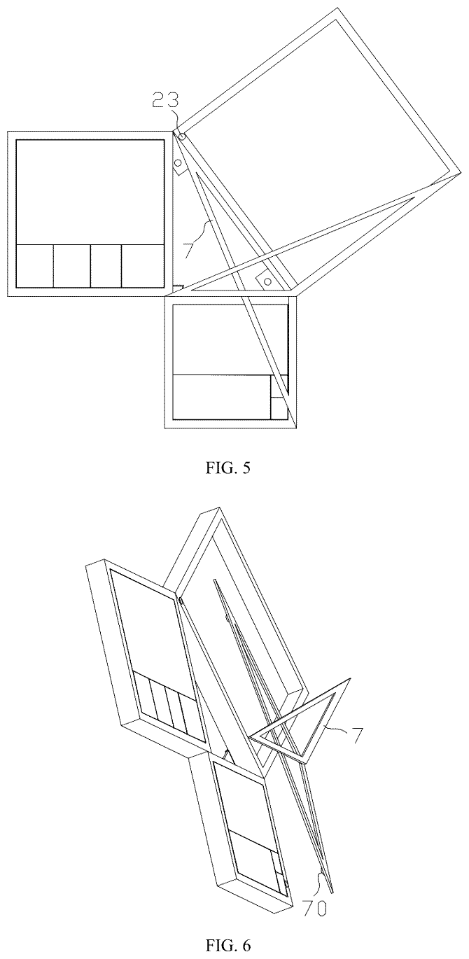

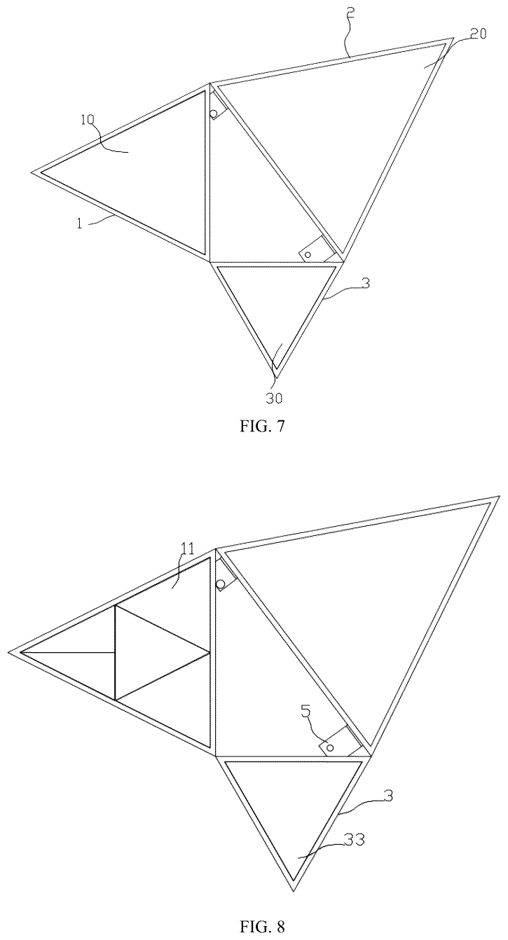

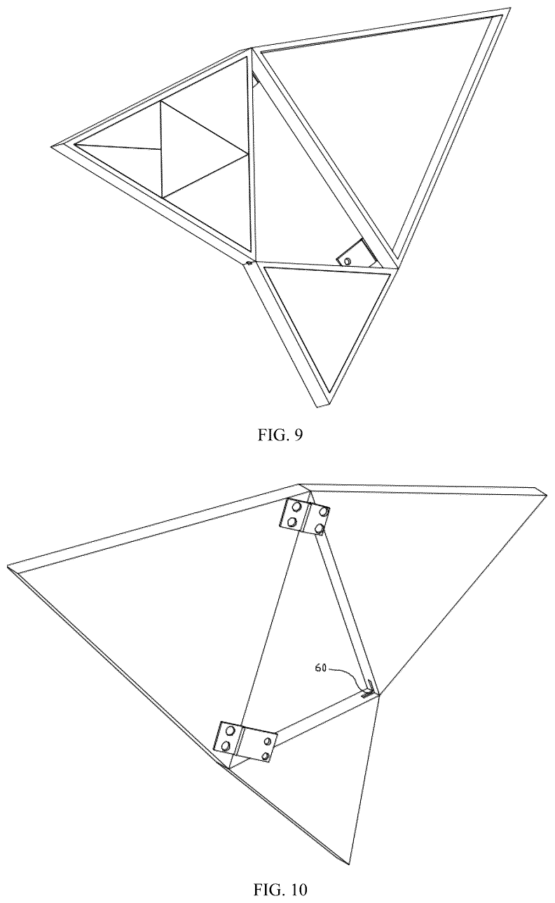

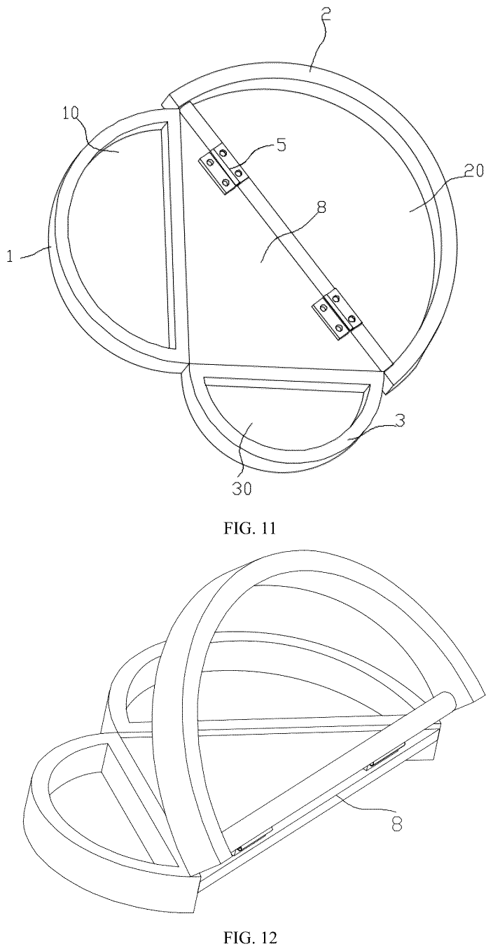

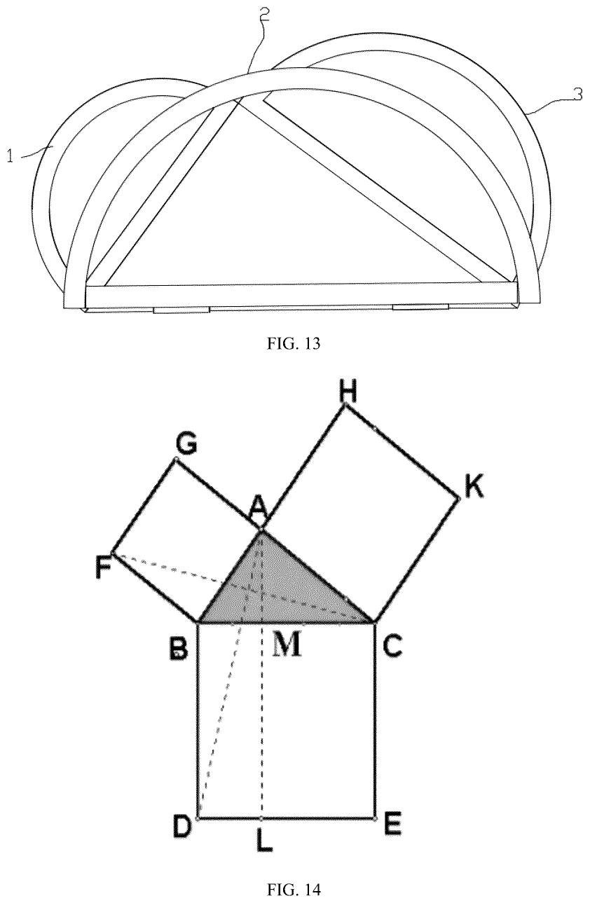

Referring to FIGS. 1-13, a splicing method of a mathematical teaching tool of the present disclosure includes the following steps; S1. providing a first carrier plate 1 with a first inner cavity 10 formed in an inner side thereof, a second carrier plate 3 with a second inner cavity 30 formed in an inner side thereof, and a third carrier plate 2 with a third inner cavity 20 formed in an inner side thereof; an edge is expanded outwardly to form a state of a carrier plate, a single linear combination is transformed into a plate shaped combination state, and the inner cavity is provided at the inner side, which can effectively convert a calculation of a length of a carrier plate into an area calculation.

S2. Splicing: connecting the first carrier plate 1 to the second carrier plate 3 in a fixed connection manner, the fixed connection includes a woodworking adhesive bonding. The cost of woodworking adhesive is low, this connection is stable after use, and it is also easy to disassemble, thereby ensuring a long service life. Connecting the third carrier plate 2 to the first carrier plate 1 in a detachable connection manner, and the detachable connection manner is a hinge lock 5, which is fixedly connected to the carrier plate by a screw. The first carrier plate 1 and the second carrier plate 3 are fixedly connected, and the third carrier plate 2 is connected to the first carrier plate 1 and the third carrier plate 2 in detachable connection way, so that when not in use, the first carrier plate 1 and the third carrier plate 2 can be flipped along the a detachable connector, and rears of the three carrier plates come into contact with each other, thereby achieving a purpose of folding and storing, and it is easy to carry.

S3. Forming a right-angled triangle area: a lower right conner of the first carrier plate 1 is connected to an upper right corner of the second carrier plate 3, an end of one side of the third carrier plate 2 is connected to an upper right corner of the first carrier plate 1, and the other end of the third carrier plate 2 is connected to the upper right corner of the second carrier plate 3. A space formed between the first carrier plate 1, the second carrier plate 3, and the third carrier plate 2 is the right-angled triangle area 4. One side of the first carrier plate 1 forms a vertical right-angled side (one edge) of the right-angled triangle area 4, one side of the second carrier plate 3 forms a horizontal right-angled side (another edge) of the right-angled triangle area 4, and one side of the third carrier plate 2 forms an oblique side of the right-angled triangle area 4. At this time, a square of a side length of the first carrier plate 1 plus a square of a side length of the second carrier plate 3 equals to a square of a side length of the third carrier plate 2.

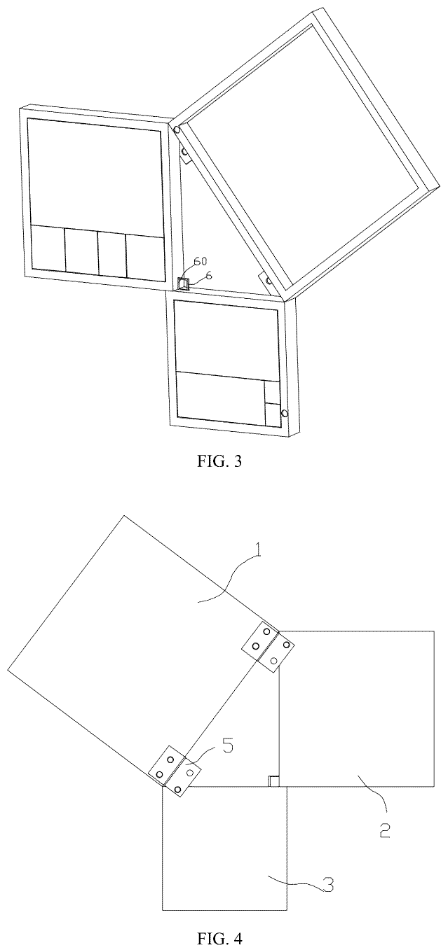

S4. Filling an area: a plurality sets of splicing plates 11 are placed on inner sides of the first inner cavity 10 and the second inner cavity 30. The splicing plates 11 formed on inner sides of the first inner cavity 10 and the second inner cavity 30 fill an inner side of the third inner cavity 20, and there is a plurality sets of the formed splicing plate 11 for easy removal or removal, rendering it more flexible and convenient to splice. Taking FIG. 2 as a reference, areas of the first carrier plate 1 formed by the splicing plate 11 are also different, with one largest splicing plate 11 and four groups of splicing plates having the same area size; the third carrier plate 2 forms a largest splicing plate 33 and two sets of small splicing plates with the same area size 33; a medium-sized splicing plate 33 increases the difficulty of filling the inner side of the third inner cavity 20 by splicing the splicing plate 11 and splicing plate 33, which effectively increases the fun of the teaching aids formed by the above-mentioned splicing method.

In this embodiment, in order to prevent the accuracy of the right angle formed by the connection between the first carrier plate 1 and the second carrier plate 3 during splicing, it is necessary to perform a right angle verification on the spliced carrier plate in step S2: a first verification groove is formed at the second carrier plate 3 close to an upper end face of a right-angled part of the right angle-triangle area 4; a second verification groove is formed at the second carrier plate 3 close to an upper end face of the right-angled part of the right-angled triangle area 4; a verification groove 60 is formed by an interconnection between the first verification groove and the second verification groove. A verification piece 6 is provided on an inner side of the verification groove 60. When splicing, it is necessary to align openings of the first verification groove and second verification groove, so that the verification piece 6 with a standard right angle can be inserted precisely to check an angle formed at a connection position between the spliced first carrier plate 1 and the second carrier plate 3.

Specifically, in step S1, when splicing, the first carrier plate 1, the second carrier plate 3, and the third carrier plate 2 are all square, and upper end faces of the first carrier plate 1, the second carrier plate 3, and the third carrier plate 2 are all provided with a prompt sign 22 on two sides, which are square in shape. A docking hole 23 can be provided on edges of the first carrier plate 1, the second carrier plate 3, and the third carrier plate 2. The docking hole 23 can be externally connected to two pairs of regular triangle plates 7 with a docking column 70; and right triangles with an edge ratio of 3:4:5 are used in this product, so that the sizes of the three regular triangles do not differ too much. And the hinge lock connection can achieve a foldability, which greatly enhances a space storage of toys. The two different cutting ways of building blocks contain two different geometric concepts. Taking the carrier plate in a shape of a square as an example, a formed area and a graphical relationship can be calculated, and the prompt signs on each side refer to FIG. 14:

```
  Goal 1: an area of a maximum square = a sum of areas of two small squares
  a. connecting C̅F̅ to A̅D̅,
  denoting as A̅L̅ ∥ B̅D̅,
  b. in Δ FBC and Δ ABD,
  as F̅B̅ = A̅B̅ and B̅C̅ = D̅B̅,
  and ∠ FBC= ∠ ABD,
  then Δ FBC ≅ Δ ABD (namely edge, angle and edge of two triangles all equal to
each other, that is, SAS congruent),
  c. in Δ ABD and rectangular BDLM, as they have the same base and height,
  thus, the area of Δ ABD=a half of the area of rectangular BDLM,
  d. in a similar way
  in Δ FBC and square ABFG, the area of Δ FBC=a half of the area of ABFG,
  therefore, the area of rectangular BDLM=the area of square ABFG
      = twice of the area of Δ ABD
      =twice of the area of Δ FBC,
  e. at this point, a half of the proof has been completed, and the next step is only to
prove:
  the area of rectangular CELM equals to the area of square ACKH,
  finally, the area of square BCED=the area of square BDLM plus the area of square
CELM
    =the area of square ABFG plus the area of square
ACKH.
```

Specifically, in step S1, when splicing, the first carrier plate 1, the second carrier plate 3, and the third carrier plate 2 are all regular triangles. When an overall structure is a regular triangle, an inner cavity formed is in a shape of a regular triangle. The splicing plate 11 placed inside is a small triangle unit that is cleverly calculated and cut, and the small triangles of the first carrier plate 1 and the second carrier plate can perfectly fill the inner cavity of the third carrier plate 2. At the same time, a right-angle verification groove 60 is formed between the first carrier plate 1 and the second carrier plate 3 in triangular shape, and an additional verification piece 6 is configured for right angle verification.

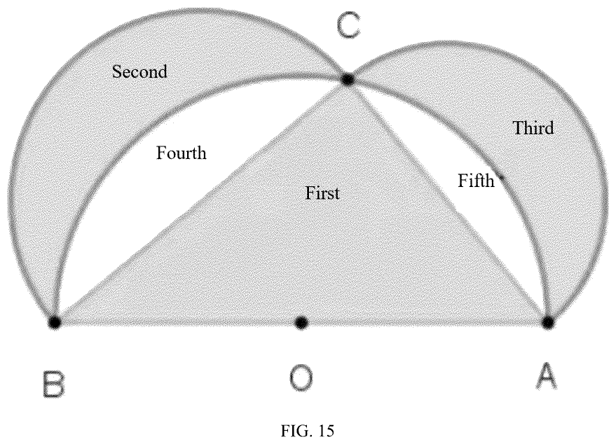

Specifically, when splicing in step S1, the first carrier plate 1, the second carrier plate 3, and the third carrier plate 2 are all semi-circular. When the structure is semi-circular, the inner cavity formed is also semi-circular. A split plate 11 is no longer used in the inner side. A right-angled triangle is formed by enclosing diameters of the three semicircles, and a right-angled triangle plate 8 is located on an inner side of the right-angled triangle area 4 formed between the semicircle shaped first carrier plate 1, the second carrier plate 3, and the third carrier plate 2. The right-angled triangle plate 8 is placed in the formed right-angled triangle area 4. At the same time, a hinge lock 5 is provided between the right-angled triangle plate 8 and a diameter edge of the third carrier plate 2 to ensure an integrity and foldability of the connection between the plates, which is facilitated to carry and prove the Hippocrate's Theorem. The right-angled triangle plate 8 can have a right-angled symbol printed on it, and the third carrier plate can also be hollow, with stickers or coloring on two crescents. Taking the carrier plate in a shape of semi-circular as an example, the formed area and graphic relationship can be calculated, and markings on each side refer to FIG. 15 (Crescent area and

Hippocrate's Theorem):
an area of a semicircle O with a diameter A̅B̅=an area of right-angled triangle (first) plus an area of bow shape (fourth) plus an area of bow shape (fifth);
an area of a semicircle with a diameter B̅C̅=an area of bow shape (fourth) plus an area of crescent (second);
an area of a semicircle with a diameter A̅C̅=an area of bow shape (fifth) plus an area of crescent (fifth);
as ∠C of the triangle ABC (right-angled triangle plate 8) is a right angle,
thus, A̅B̅²=B̅C̅²+A̅C̅²,therefore,

$$( \frac{1}{2} ) {π ( \frac{\overline{AB}}{2} )}^{2} = ( \frac{1}{2} ) {π ( \frac{\overline{BC}}{2} )}^{2} plus ( \frac{1}{2} ) {π ( \frac{\overline{AC}}{2} )}^{2} ,$$

an area of a semicircle O with a diameter of A̅B̅=an area of a semicircle with a diameter B̅C̅ plus an area of a semicircle with a diameter A̅C̅;
the area of the shapes (first+second+third)=the area of the shapes (second+fourth)+the area of shapes (third+fifth), thus, the area of A=area of B+area of C, so the area of right-angled triangle ABC is equal to the sum of areas of crescent (second) and crescent (third).

The above is only a preferred embodiment of the present disclosure and does not limit the scope of the present disclosure. Any equivalent structural changes made with the description and drawings of the present disclosure, or directly/indirectly applied in other related technical fields, are included in the protection scope of the present disclosure.

What is claimed is:

1. A splicing method of a mathematical teaching tool, comprising:
S1: providing a first carrier plate, a second carrier plate, and a third carrier plate;
wherein a first inner cavity is formed in an inner side of the first carrier plate;
a second inner cavity is formed in an inner side of the second carrier plate;
a third inner cavity is formed in an inner side of the third carrier plate;
S2. splicing: connecting the first carrier plate to the second carrier plate in a fixed connection manner, connecting the third carrier plate to the first carrier plate in a detachable connection manner;
S3. forming a right-angled triangle area: a lower right corner of the first carrier plate is connected to an upper right corner of the second carrier plate, an end of one side of the third carrier plate is connected to an upper right corner of the first carrier plate, and the other end of the third carrier plate is connected to the upper right corner of the second carrier plate, a space formed between the first carrier plate, the second carrier plate, and the third carrier plate is the right-angled triangle area;
S4. filling an area: a plurality sets of splicing plates are placed at inner sides of the first inner cavity and the second inner cavity, the splicing plates formed at the inner sides of the first inner cavity and the second inner cavity fill an inner side of the third inner cavity.

2. The splicing method of a mathematical teaching tool according to claim 1, wherein in step S2, performing a right-angle verification on a spliced carrier plate:
wherein a first verification groove is formed at the first carrier plate close to a side surface of a right-angled part of the right-angled triangle area;
a second verification groove is formed at the second carrier plate close to an upper end face of the right-angled part of the right-angled triangle area;
a verification groove is formed by an interconnection between the first verification groove and the second verification groove, and a verification piece is provided on an inner side of the verification groove.

3. The splicing method of a mathematical teaching tool according to claim 1, wherein in step S2, the fixed connection comprises a woodworking adhesive bonding.

4. The splicing method of a mathematical teaching tool according to claim 2, wherein in step S2, the fixed connection comprises a woodworking adhesive bonding.

5. The splicing method of a mathematical teaching tool according to claim 3, wherein in step S2, the detachable connection is a hinge lock.

6. The splicing method of a mathematical teaching tool according to claim 1, wherein in step S1, the first carrier plate, the second carrier plate, and the third carrier plate are all squares, and upper end faces of the first carrier plate, the second carrier plate, and the third carrier plate are all provided with a prompt sign on two sides.

7. The splicing method of a mathematical teaching tool according to claim 1, wherein in step S1, the first carrier plate, the second carrier plate, and the third carrier plate are all regular triangle.

8. The splicing method of a mathematical teaching tool according to claim 1, wherein in step S1, the first carrier plate, the second carrier plate, and the third carrier plate are all semi-circular.
